(19) United States
(12) Patent Application Publication
(10) Pub. No.: US 2021/0348691 A1
(43) Pub. Date: Nov. 11, 2021

(54) MULTI-WAY VALVE ASSEMBLIES FOR FLOW CONTROL OF A FLUID

(71) Applicant: CLIMEO AG, Hinwil (CH)

(72) Inventors: Daniel BURKHALTER, Hinwil (CH); Christoph POLTERA, Wetzikon (CH); Olivier SCHMID, Dübendorf (CH)

(21) Appl. No.: 17/278,117

(22) PCT Filed: Sep. 20, 2018
(86) PCT No.: PCT/EP2018/075401

§ 371 Date: Mar. 19, 2021

(51) Int. Cl. F16K 11/18; F16K 27/00

(52) U.S. Cl. CPC F16K 11/18; F16K 27/003

(57) ABSTRACT

A first aspect of the present invention relates to a multi-way valve assembly (M) for flow control of a fluid. The valve assembly has at least first and second valve elements (12a-h) and actuating mechanism (70) for actuating the valve elements (12a-h). The valve elements are arranged in such a way that, depending on the position of the actuating mechanism (70), at least one predetermined valve element (12a) can be selected and actuated. The actuating mechanism (70) is arranged to be translationally displaceable. In a first translational position of the actuating mechanism (70), the first valve element (12a) can be actuated, and, in a second translational position different from the first translational position, the second valve element (12b) can be actuated.

### FIELD OF THE INVENTION

The present invention relates to various multi-way valve assemblies as claimed in the preambles of the independent claims.

### BACKGROUND OF THE INVENTION

In heating and ventilation technology, irrigation technology and formulation control in process engineering, generally valves of very different construction, in particular sliding valves and other diaphragm valves, as well as solenoid valves and ball valves, are used for flow control. In particular, in heating and cooling systems it is frequently necessary and desired, starting from a central supply and/or a central discharge, to control separately and independently of one another a plurality of partial regions to be heated or to be cooled, for example when heating/ventilating different rooms of a house. Nowadays valves which are able to be regulated separately are generally used for such applications, wherein in each case all of the valves have all the mechanical and/or electrical devices required for the regulation. As a result, a modular construction of a multi-way valve assembly is possible. However, this results in highly complex equipment due to the fully autonomous construction of the individual valves. As a result, both the costs and the space requirement of such as system is disadvantageous.

A multi-way valve for supplying a fuel cell system with gas is disclosed in the document EP 2 918 879. The multi-way valve has a tubular through-passage with an inlet opening. A plurality of outlet openings which may be opened and closed by closing bodies are provided on the through-passage. The disclosed mechanism for operating the closing bodies, however, is complex and a pressure equalization between the different lines is not able to be performed.

DE 10 2012 214 845 discloses a multi-way valve for a motor vehicle cooling system. The valve has a single actuator which activates a plurality of channel bodies which are generally of cylindrical shape. However, the control of the channel bodies is such that the channel bodies are coupled together. Thus the document has the drawback that the channel bodies are generally not able to be controlled independently of one another.

The patent EP 1 515 073 discloses a multi-way valve assembly for flow control. The multi-way valve assembly has a plurality of valve elements which may be activated by actuating means. The valve elements are of the same construction and may be selected and actuated as a function of an angular amount of a rotation of the actuating means.

### SUMMARY OF THE INVENTION

It is the object of the invention to remedy the drawbacks of the prior art. In particular, a valve assembly which permits a plurality of valve elements to be activated independently of one another is intended to be provided. Specific embodiments may have the advantage that the plurality of valve elements may be activated in a confined space by means of a simple and compact device.

A first aspect of the present invention relates to a multi-way valve assembly for flow control of a fluid. The fluid may be liquid or gaseous. Thus, for example, water and/or airflows may be controlled by the valve assembly. The valve assembly has at least a first and a second valve element and actuating means for actuating the valve elements. The valve elements are preferably of the same construction. The valve elements are arranged in such a way that, depending on the position of the actuating means, at least one predetermined valve element can be selected and actuated. The actuating means are arranged to be translationally displaceable. Preferably the actuating means may be translationally displaced along a longitudinal axis of a main line of the valve elements. In a first translational position of the actuating means, the first valve element can be actuated, and in a second translational position, different from the first, the second valve element can be actuated. Further valve elements are actuatable when the actuating means are located in further translational positions.

The first and the second valve element (and optionally further valve elements) are connected, in particular braced, together by fastening means. The fastening means may comprise one or more threaded rods.

The valve elements are preferably hollow and may form together a main line. The first and the second valve element are preferably configured in order to open and close a first and/or a second valve line which feeds into the main line. In a preferred variant, the actuating means are at least partially arranged in the main line. In a preferred variant, the actuating means are at least partially encompassed by the valve elements. The actuating means are preferably of elongated configuration and extend along an axis of the main line.

The valve assembly as claimed in the independent claim(s) has the advantage that all of the valve elements may be activated and may be actuated by a common actuating means. Additionally, the number of valve elements which may be activated by the actuating means is only limited by the translational displaceability of the actuating means.

A further optional advantage is that a simple control may be provided since the actuating means are able to activate all of the valve elements.

In preferred embodiments, the device has three, four, five or more individually activatable valve elements. In a specific embodiment, the device has eight valve elements. In a further preferred embodiment, the device has 12 individually activatable valve elements.

In a preferred embodiment, the actuating means comprise a shaft, wherein the shaft is preferably arranged to be axially displaceable along its axis, so that in a first axial position of the shaft the first valve element is actuatable, and in a second axial position, which is different from the first, the second valve element is actuatable. As a result, particularly simple actuating means may be provided. In one embodiment, the shaft may be exclusively axially moved and rotated about its own axis.

In a preferred embodiment, the assembly also has a pressure equalization device. The pressure equalization device is preferably actuatable in a further (for example third) translational position of the actuating means. As a result, a hydrostatic equalization may be produced between the valve lines of the valve elements.

The third translational position is preferably a final translational position in a direction of displacement of the actuating means. As a result, an adaptation of the valves and of the hydrostatic equalization may be implemented more rapidly, since initially the valve elements may be actuated and then the hydrostatic equalization (or vice versa) without the actuating means having to be displaced to and fro.

In a preferred embodiment, the valve assembly has a third valve element. In the first translational position of the actuating means the first and the third valve element are actuatable. In this case the first and the third valve element, in particular, are selectable and actuatable as a function of an angular amount by a rotation of the actuating means. As a result, a plurality of valves may be brought closer to one another in the same translational position, which permits a compact valve assembly.

In a variant, the actuating means may be embodied as in EP 1 515 073. In a preferred embodiment, the first valve element is selectable by a first rotational position of the actuating means and the third valve element is selectable by a second rotational position of the actuating means which is different from the first. The rotational position may be a specific angle but also an angular range in which the corresponding valve element is activatable.

Preferably in a third translational position the actuating means are either moved into the first or into the third rotational position and then the actuating means are displaced into the first translational position. In the first translational position, therefore, the selected valve element (i.e. the first or the third) may be actuated.

In the third translational position the actuating means are preferably not engaged. In other words, in the third translational position no valve element is able to be actuated, or a different device is able to be actuated.

In a preferred embodiment, the first valve element is actuatable by a rotation of the actuating means in a first direction and a valve, for example the third valve element, is actuatable by a rotation in a second direction which is different from the first. In particular, the actuating means may be rotated about their own axis in order to actuate selectively the first or the third valve element. In particular, the first valve element may be opened by the rotation, whilst the second valve element may be closed by the counter-rotation. In a second rotational position the reverse actuation is possible, i.e. the closing of the first valve element when rotating in the second direction and the opening of the second valve element when rotating in the first direction.

In an alternative embodiment, two or more valve elements may be actuated at the same time by the actuating means.

In a preferred embodiment, the valve elements have a body and a diaphragm. The diaphragm may be movably, preferably rotatably, arranged relative to the body. Preferably the diaphragm may be rotated about an axis of the main line. The diaphragm is rotatable into a first position in which a valve line of the valve element is open. Moreover, the diaphragm is rotatable into a second position in which the line of the valve element is closed.

Moreover, the diaphragm may be movable by the actuating means relative to the valve body. In a variant, the diaphragm has the shape of a hollow tube. The diaphragm may comprise at least one driver for the actuating means. The actuating means may be designed to actuate the drivers. The drivers preferably extend in a radially internal direction of the hollow tube. The drivers may be elongated, particularly preferably the drivers are configured as pins.

Preferably a plurality of the diaphragms or all of the diaphragms have one or two or more drivers for the actuating means. Two or more drivers have the advantage that forces and moments may be transmitted more effectively. The diaphragm is preferably arranged in a cavity of the valve body. Particularly preferably, the diaphragm/diaphragms is/are arranged in the main line. The diaphragm or the diaphragms preferably have at least a first and a second offset receiver for the drivers. The receivers may be preferably configured as round through-holes. The receivers are preferably offset along a longitudinal axis of the diaphragm relative to one another in the circumferential direction. Individual diaphragms may be selected when activated by the actuating means, due to the axially offset receivers.

This has the advantage that the diaphragms may be produced with the same construction and only differ in the mounting of the drivers.

Alternatively, the different diaphragms may be of different construction and the pins may be attached at different axial positions.

A further aspect of the invention relates to a multi-way valve assembly for flow control and distribution of a fluid. The assembly comprises at least a first and a second valve line with a common main line. The first and the second valve line preferably branch off from the main line. The assembly has at least a first and a second valve element for closing and opening the first, respectively the second, valve line. The valve elements are arranged between the valve line and the main line. The assembly also has actuating means for actuating the valve elements.

According to this aspect an actuatable pressure equalization device is provided for pressure equalization in the main line, in particular in a component.

In buildings, various consumers, for example heating systems, are located on different floors. As a result, the fluid has a variable pressure when, for example, it flows back into the multi-way valve assembly. The pressure equalization device adapts these pressures to a desired pressure downstream, in particular in the return line, of the valve assembly. At the same time, the pressure ratios of the individual flows from the valve lines are equalized relative to one another.

In a preferred embodiment, the pressure equalization device is arranged such that a fluid flow passes substantially entirely through the pressure equalization device. As a result, it is ensured that the pressure of the entire fluid is equalized.

The valve elements are preferably of the same construction. The component is preferably able to be connected to the valve elements. The component is, in particular, for a hydrostatic equalization. The main line is preferably tubular. Preferably the component forms a part of the main line. A longitudinal axis of the main line is preferably at right angles to a longitudinal axis of the valve lines. The valve elements preferably have a valve body with a through-opening for the valve lines.

In a preferred embodiment, the pressure equalization device comprises a slide. The slide is in an outlet cross section slide. Preferably the slide is rotatable. In a particularly preferred embodiment, the slide is arranged in the cross section of the main line. The slide may be fastened to a web which extends through a cross section of the main line. In a first position in which the slide does not block the outlet, the slide may extend along the web. In a second position the slide may at least partially cover the outlet.

In a preferred embodiment, the pressure equalization device is designed to close the outlet at least partially.

In a preferred embodiment, the pressure equalization device is actuatable by a drive. Particularly preferably, the pressure equalization device is actuatable by the same actuating means as the valve elements. As a result, the pressure equalization device may be activated in a simple manner.

A further aspect of the invention relates to a multi-way valve assembly for flow control and distribution of a fluid. The valve assembly has at least a first and a second valve line with a common main line. The assembly also has at least a first and a second valve element for closing, respectively opening, the first and second valve line. The valve elements are arranged between the respective valve line and the main line. Moreover, the assembly has actuating means for actuating the valve elements. The actuating means have a shaft which is arranged in the main line and which is of hollow configuration.

As a result, a fluid may flow through the shaft. As a result, a flow through the main line may be increased so that the assembly, for example, may be of smaller construction or larger volumes may be processed.

In a preferred embodiment, the shaft has holes so that a fluid may flow from outside to inside and at one end of the shaft may flow out of the shaft. The holes are preferably distributed in an axial direction of the shaft.

In a preferred embodiment, the holes are arranged according to an anticipated volumetric flow. For example, the holes in a first portion may have a first spacing from one another and in a second portion may have a second shorter spacing. Thus the spacings between the holes in the axial direction may be shorter in valve elements in which a high volumetric flow is anticipated, and may be greater in valve elements at which a low volumetric flow is anticipated.

In an alternative embodiment, the holes are distributed evenly over the length of the shaft. Alternatively, the holes may also be distributed unevenly. Thus, for example in valve elements with high volumetric flows, a relatively high number of holes and/or larger holes may be arranged.

In a preferred embodiment, the shaft is open at least at one end. Preferably the end is arranged in the direction of the outlet of the valve assembly. As a result, the flow conditions in the shaft are optimized.

A further aspect of the invention relates to a multi-way valve assembly, preferably a valve assembly as described above. The valve assembly has a measuring cell for measuring a volumetric flow. The measuring cell is preferably arranged in the main line. Alternatively, each of the valve lines could have a measuring cell. Particularly preferably the measuring cell is arranged in the component. The measuring cell may comprise an impeller for measuring the flow. In a preferred embodiment, the measuring cell is replaceable. Moreover, one or more sensors may be provided in the measuring cell for a temperature measurement.

A further aspect of the invention relates to a multi-way valve assembly for flow control and distribution of a fluid. The valve assembly, in particular, is a valve assembly as described above. The actuating means have a switching element. The switching element is preferably a shaft. The valve assembly also has a drive unit for the actuating means. One or more motors for the drive unit are arranged laterally offset relative to a longitudinal axis of the main line.

The drive unit translates the movement of the motor to the actuating means (for example the shaft). The drive unit is preferably arranged along an axis of the common main line.

During the installation of the aforementioned assemblies, the space is frequently limited. In particular, space is frequently limited in the longitudinal direction of the main line. The proposed drive unit makes it possible to mount the motor laterally offset relative to the longitudinal axis and to save space as a result.

In a preferred embodiment, the drive unit has a drive shaft with a rotational direction perpendicular to the longitudinal direction of the main line. Further preferably the drive unit has a worm gear in order to translate the rotation of the drive shaft into a longitudinal movement and/or translation of the actuating means. The drive shaft is preferably a worm shaft of a worm gear. As a result, the motor may be arranged in a space-saving manner.

In a preferred embodiment, the drive unit is designed to displace and to rotate the switching element axially to the main direction. Further preferably, the axial displacement and the rotation are decoupled from one another.

A further aspect of the invention relates to a multi-way valve assembly for flow control, in particular to a valve assembly which is designed as described above. The multi-way valve assembly comprises a first valve element and a second valve element. The valve elements have in each case a valve body with an opening. The opening is closable by a diaphragm. A seal is attached between the opening and the diaphragm. The seal is pressed against the diaphragm. Preferably the seal is pressed by a spring element against the diaphragm. In one embodiment, the seal may be made of Teflon.

As a result, it is possible to provide a seal between the valve body and the diaphragm. Preferably the spring element is annular.

A further aspect of the invention relates to a multi-way valve assembly for flow control. The actuating means may have a shaft and/or contain a switching element for transmitting a translational and/or rotational movement to the shaft. The switching element may be immovably connected to the shaft.

The assembly may have a drive unit for the actuating means. The drive unit may contain a pivoting arm which is coupled to the actuating means, in particular the switching element. The pivoting arm is arranged such that the shaft is axially displaceable by a rotation of the pivoting arm.

In multi-way valve assemblies in which fluids are transported, a reliable seal is difficult to achieve, primarily if elements which are movably arranged in the fluid chamber are intended to be driven from the outside. A control via a pivoting arm permits, for example, a simple annular seal. Seals which are intended to seal axial movements through a housing are complex and in some instances fail more rapidly. Such seals may be avoided by the pivoting arm.

In a preferred embodiment, the pivoting arm and the shaft are coupled such that only forces acting axially to the shaft are able to be transmitted from the pivoting arm to the shaft. Preferably the shaft has a switching element or is axially connected to a switching element. The pivoting arm may have a pin which is guided through the switching element in a direction transversely to the longitudinal axis. In this case, the pin is preferably free perpendicular to the longitudinal axis and forces may be transmitted along the longitudinal axis.

In a preferred embodiment, the motor has a rotary motor in order to rotate the shaft about its own axis. Particularly preferably, the rotary motor is coupled via a worm gear to the shaft.

In a preferred embodiment, all of the seals are annular around movable parts. Particularly preferably, forces are transmitted from the motor to the drive unit exclusively via rotation.

In a preferred embodiment, the first and the second valve element in each case have a valve body and the valve bodies are arranged adjacent to one another in the longitudinal direction relative to the main line.

In a preferred embodiment, at least one sliding element is arranged between the valve body and the diaphragm. Preferably, the sliding element is arranged on a radial outer face of the diaphragm. The diaphragm may be displaced more easily between the open and closed position by means of the sliding element.

In a preferred embodiment, the valve elements in each case have a movable diaphragm. A movement, in particular a rotation, of the diaphragm is limited by a stop device. As a result, the movement of the diaphragm may be limited and an operation of the diaphragm may be simplified.

In a preferred embodiment, the diaphragm is of hollow-cylindrical configuration and is arranged to be rotatable about its axis. The stop device is preferably configured by a stop pin which is guided in a slot of the diaphragm. Alternatively, a slot or an elongated groove may also be configured in the valve body and the diaphragm contains the pin (kinematic reversal).

The above-described multi-way valve assemblies are particularly suited for flow control of an air-conditioning system or a heating system, in particular a water heating system in buildings.

A further aspect of the present invention relates to the use of a multi-way valve assembly as described above for flow control in an air-conditioning system or in a heating system.

A further aspect of the invention relates to a heating system and/or a cooling system which contains at least one multi-way valve assembly as described above.

### BRIEF DESCRIPTION OF THE DRAWINGS

The invention is described in more detail hereinafter with reference to the figures which show merely exemplary embodiments. In the drawings, schematically:

FIG. 1: shows a multi-way valve assembly according to the present invention,

FIG. 2A: shows a valve element for the multi-way valve assembly according to FIG. 1,

FIGS. 2B and 2C: shows sectional views of the valve assembly according to FIG. 2A,

FIG. 3: shows a valve element with a diaphragm for the valve element,

FIGS. 4A and 4B: show various perspective views of the diaphragm of FIG. 3,

FIG. 5A: shows a perspective view of actuating means of a multi-way valve assembly according to FIG. 1 and a diaphragm,

FIG. 5B: shows a sectional view of the actuating means of FIG. 5A,

FIG. 6A: shows a first perspective internal view of a drive unit,

FIG. 6B: shows a second perspective internal view of the drive unit,

FIG. 7A: shows a third perspective internal view of the drive unit,

FIG. 7B: shows a perspective exploded view of the drive unit,

FIG. 8A: shows a perspective view of a component for a multi-way valve assembly according to FIG. 1, and

FIG. 8B: shows a perspective internal view of the component according to FIG. 8A.

### DETAILED DESCRIPTION OF THE PREFERRED EMBODIMENTS

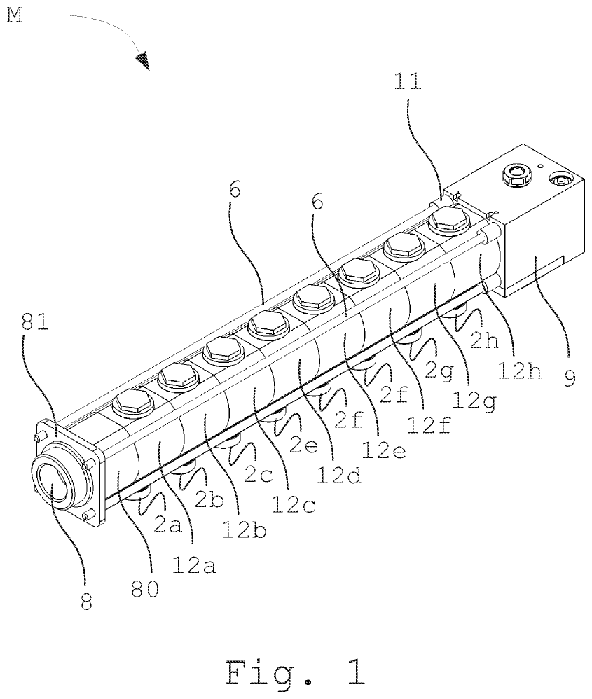

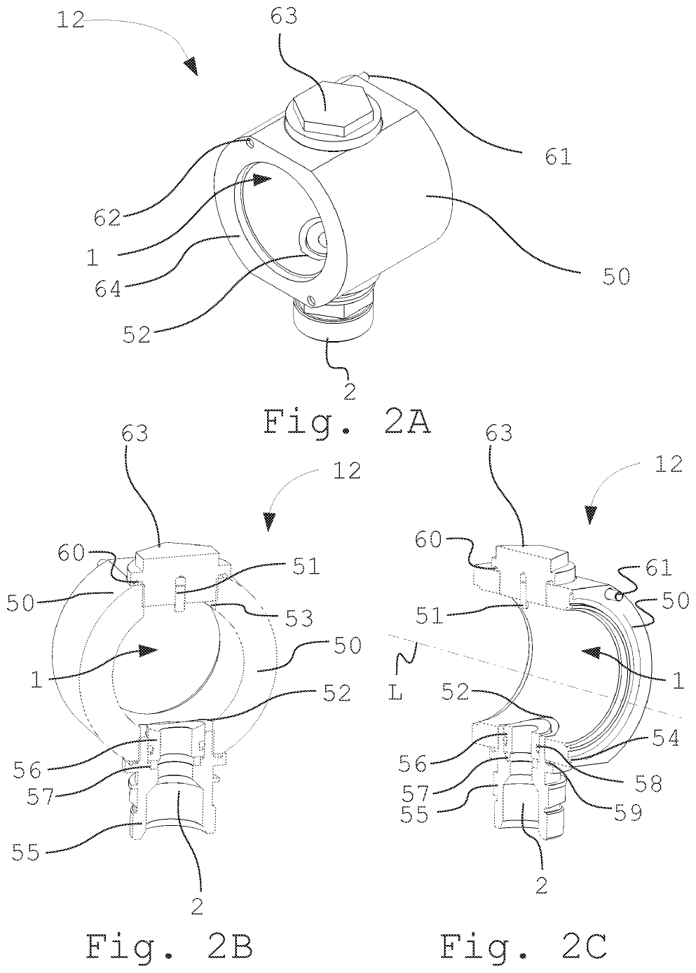

FIG. 1 shows a perspective view of a multi-way valve assembly M. The valve assembly M contains a plurality of valve elements 12a to 12h and a drive unit 9. The valve elements 12 are configured as tubular portions and are internally hollow. Together the valve elements 12 form a main line 1 (see FIGS. 2A to 2C). A valve line 2a to 2h which extends transversely from the main line 1 is configured on each of the valve elements 12a to 12h. At the valve lines 2a to 2h a fluid, in particular water, is conducted into the main line 1 or branched off from the main line 1. The main line 1 opens into a similarly tubular component 80. The fluid flows through an outlet or inlet 8 into the valve assembly M or out of the valve assembly M. Hereinafter it is assumed that a fluid flows in through the valve lines 2a to 2h and flows out of the outlet 8 via the main line 1. Naturally the reverse path is also conceivable, i.e. the fluid flows in through the inlet 8 and flows out through the valve lines 2a to 2h.

The valve elements 12 are of identical construction and arranged adjacent to one another. The valve elements 12 are able to be plugged into one another and are held together by threaded rods 6. The threaded rods 6 are fixed on the side of the outlet 8 to a flange 81 of a component 80, and on the other side to connectors 11 for the threaded rods which are attached to the drive unit 9. The valve elements 12 are fixed together via nuts which may be attached to the side of the flange.

FIGS. 2A to 2C show one of the valve elements 12 in detail. FIG. 2A is a perspective view of an isolated valve element 12 whilst different sectional views of the valve element 12 are shown in FIGS. 2B and 2C.

The valve element 12 comprises a substantially round tubular valve body 50. As described in connection with FIG. 1, the valve elements are connected together via a plug connection. For the plug connection the valve body has one or more pins 61. The pin 61 is in each case plugged into a corresponding receiver 62 of an adjacent further valve element 2. Additionally the body 50 has a seal 54 on a connecting surface 64 which is adjacent to the next valve element 12 (or to the component 80 or to the drive unit 9). The seal 54 is designed as an O-ring. The valve elements 12 are pressed against one another by the threaded rods 6 (see FIG. 1), so that the seal 54 prevents fluid from escaping between the individual valve elements 12.

The valve body 50 has in an upper part a first receiver opening 53 for a closure cap 63. The closure cap 63 is inserted into the opening 53 and fixed, for example, to the valve body 50 via a thread. An O-ring seal 60 is pressed against the valve body 50 and against the closure cap 63 by tightening the thread, and seals the receiver opening 53. Additionally a stop pin 51 is fixed in the closure cap 63. The stop pin 51 extends into the main line 1 and, in particular, perpendicular to the longitudinal axis L of the main line 1.

Moreover, the valve body 50 has a second receiver opening 52 for a line part 55. The line part 55 is also hollow and tubular and, as a result, forms the valve line (here by way of example for one of the valve outputs 2a to 2h denoted by 2). The line part 55 is screwed via a thread between the valve body 50 and the line part 55 so that the O-ring 59 is pressed against the valve body 50. A seal is formed between the valve body 50 and the line part 55 by a further O-ring 59 (see FIG. 2C).

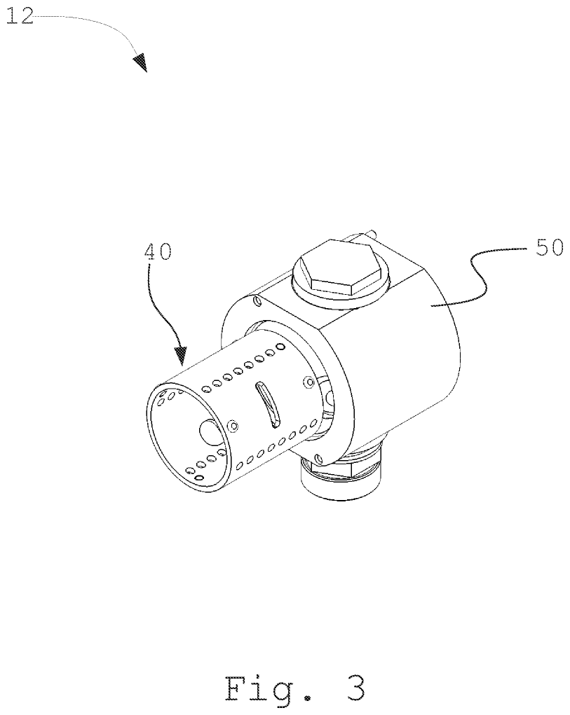

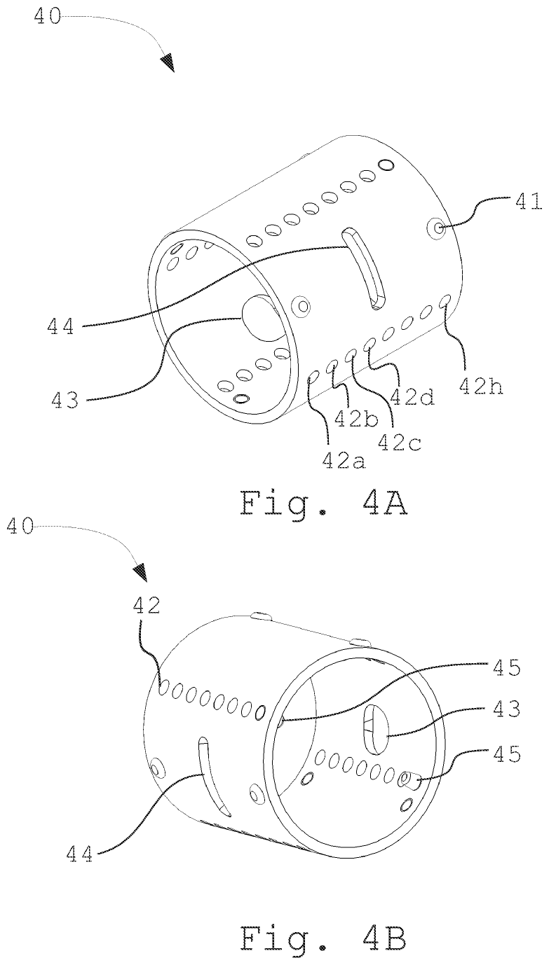

Additionally the line part 55 has a line seal 56. The line seal 56 provides a seal between a diaphragm 40 (see FIG. 3 and FIGS. 4A and 4B) and the line part 55. To this end, a third O-ring 58 is provided between the seal 56 and the line part 55. A spring, preferably an elastic spring element 57, is arranged between the line seal 56 and the line part 55 in the axial direction of the valve line. The elastic spring element 57 presses the line seal 56 in the direction of the main line 1. As a result, the line seal 56 is pressed against the diaphragm 40 so that when the diaphragm is closed no leakage flow or only a very small leakage flow is produced from the valve line 2 into the main line 1.

FIG. 3 shows a complete valve element 12. The valve element 12 contains the diaphragm 40 in addition to the valve body 50 (with the components according to FIGS. 2A to 2C). The diaphragm 40 is rotatably mounted in the valve body 50.

The diaphragm 40 is described hereinafter in detail with reference to FIGS. 4A and 4B which show perspective views of the diaphragm 40. The diaphragm 40 is a tubular part with sliding pads 41 on the radial outer face. The sliding pads 41 permit the diaphragm 40 to be rotatably held in the main line 1 by the valve body 50 about its own axis.

Additionally the diaphragm 40 has an elongated stopper slot 44. The stop pin 51 (see FIG. 2B and FIG. 2C) is guided in the stopper slot 44. A rotation of the diaphragm 40 in the main line 1 is limited to a specific angular range by the stopper slot 44.

On an opposing side to the stopper slot 44, the diaphragm 40 has a round diaphragm opening 43. If the diaphragm opening 43 is overlapped by an outlet of the valve line 2, a fluid may flow from the valve line 2 into the main line 1. If the diaphragm 40 is rotated, it closes the valve line 2.

The diaphragm is actuated via drivers which are configured as pins 45. The pins 45 are held in receivers 42 for the pins 45. The diaphragm 40 shown has a series of eight adjacent receivers 42a to 42h for pins 45 in the longitudinal direction of the diaphragm 40. Additionally the diaphragm in the circumferential direction has four such series, with in each case eight adjacent receivers 42a to 42h for the pins 45. In the circumferential direction the series are separated by an angle of 90°.

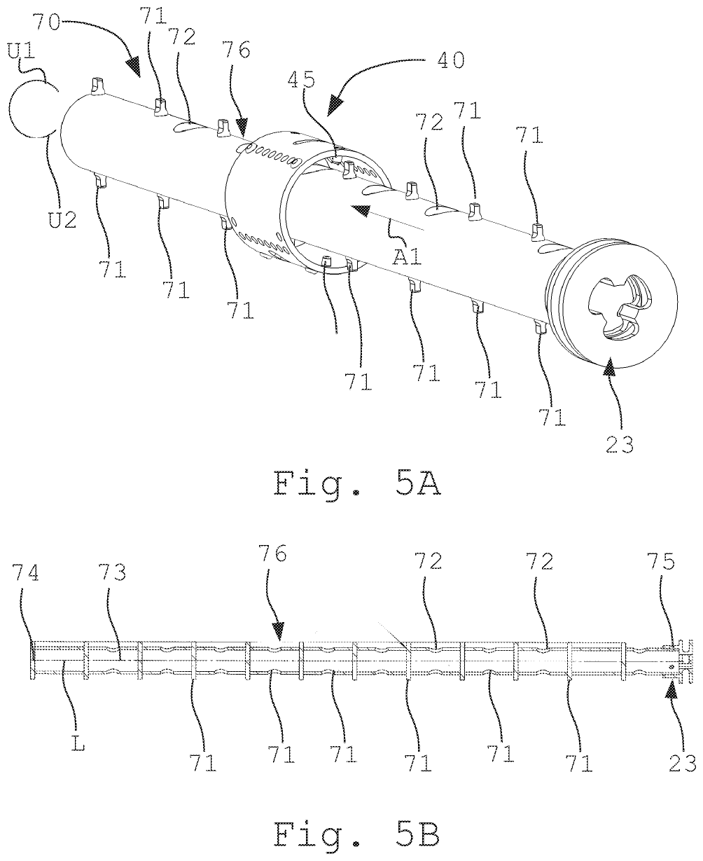

As may be seen in FIG. 4B, the pins 45 are fastened only in two (opposing) receivers (i.e. for example separated by 180°). The pins 45 are selected and activated by actuating means 70 (see FIGS. 5A and 5B). Each of the eight valve elements 12 of FIG. 1 has a diaphragm 40. The diaphragm shown in FIG. 4B could be part of the valve element 12a, for example, since the pins 45 are fixed in the receiver 42a. In the valve body 2b the pins could then be fixed in opposing receivers 42b, etc.

FIG. 5A shows the actuating means 70 and a diaphragm 40. The actuating means 70 have a shaft 76 and a switching element 23. The switching element 23 is fixed by rivets 75 (see FIG. 5B) to the shaft 76. The shaft 76 is arranged in the main line 1 and may be axially displaced therein in the longitudinal direction L. Additionally the shaft 76 may be rotated about its own axis. A plurality of drivers 71 is arranged on a radial outer face of the shaft 76. The drivers 71 are able to be brought into engagement with the pins 45 of the diaphragm 40. Thus the drivers 71 are flat on a circumferential side of the shaft in the longitudinal direction L. The drivers 71 are configured as elongated pins which are inserted through the shaft 76.

For actuating the diaphragm 40 the shaft 76 is displaced in the longitudinal direction L until a driver 71 and a pin 45 are at the same axial position. Then the shaft is rotated so that the driver rotates the pin 45 and thus the diaphragm 40. Depending on the direction in which the diaphragm 40 is intended to be rotated, the shaft 76 has to be rotated to the corresponding side of the pin 45 in the circumferential direction. Since the shaft 76 and the diaphragm 40 in each case have two pins 45/drivers 71 at the same axial position, in the case of an actuation two pins are always driven.

If the diaphragm is intended to be rotated in one direction U1, for example, the shaft 76, which is shown, is displaced in the axial direction A1 and then rotated in the direction U1 until the desired position is reached. For the opposing direction U2, before the pin 45 and the driver 71 are brought into engagement, the shaft 76 would have to be rotated in the direction U1 so that the driver passes behind the pin 45. Then the shaft may be axially displaced again, brought into engagement with the pin 45 and the diaphragm rotated in the direction U2.

The drivers 71 are arranged at equal spacings on the shaft 76. Since each of the valve elements 12a to 12h is intended to be activatable individually, the pins 45 are fastened to different receivers 42a to 42h in different diaphragms 40a to 40h of the valve elements 12a-h. Thus via the axial position of the shaft it may be determined which valve element 13 is activated. In a first axial position, for example, the diaphragm for the valve element 12a is activatable, since in this position the drivers 71 may be brought into engagement with the diaphragm 40a for the valve element 12a. In this axial position only the diaphragm 40a is activatable. The remaining diaphragms have their pins at other positions so that in the case of an actuation of the valve element 40a the corresponding drivers 71 rotate without being engaged.

In a second axial position the diaphragm 40b is able to be controlled for the valve element 12b since in this position one of the drivers 71 is able to be brought into engagement with the corresponding pin 45 of the diaphragm 40B of the valve element 12B. This applies equally to the further valve elements 12c to 12h. In a further axial position none of the valve elements is actuatable by the shaft 76. In this position the shaft may be freely rotated and a rotational position of the shaft may be selected in order to determine in which direction a valve element is intended to be actuated.

In a variant, two valve elements may be activatable in the first axial position. In this case the pins 45 are arranged in the diaphragm between the two valve elements 12 in the same position offset by 90° (see the empty series 42a-h in FIG. 4A). If the first valve element is intended to be activated, the shaft 76 is initially moved into a corresponding rotational position and then axially displaced until a driver 71 overlaps the corresponding pins 45. For the activation of the second valve element the shaft initially has to be displaced back again, and rotated by 90° in order to pass in turn into the first axial position. Thus a plurality of valve elements may be activatable at the same time in one axial position. An example of such a rotational selection is disclosed in the patent application EP 1 515 073.

The shaft 76 as shown in FIG. 5B is internally hollow and has an internal chamber 73. One end 74 of the shaft is open. Apertures 72 are arranged between the drivers 71. The fluid may flow into the interior 73 of the shaft through the diameters 72 and then flow out at the end of the shaft 74. As a result, a flow capacity of the valve assembly may be increased, since the cross section of the shaft 76 is also utilized.

The switching element 23 is described in detail in connection with the following figures.

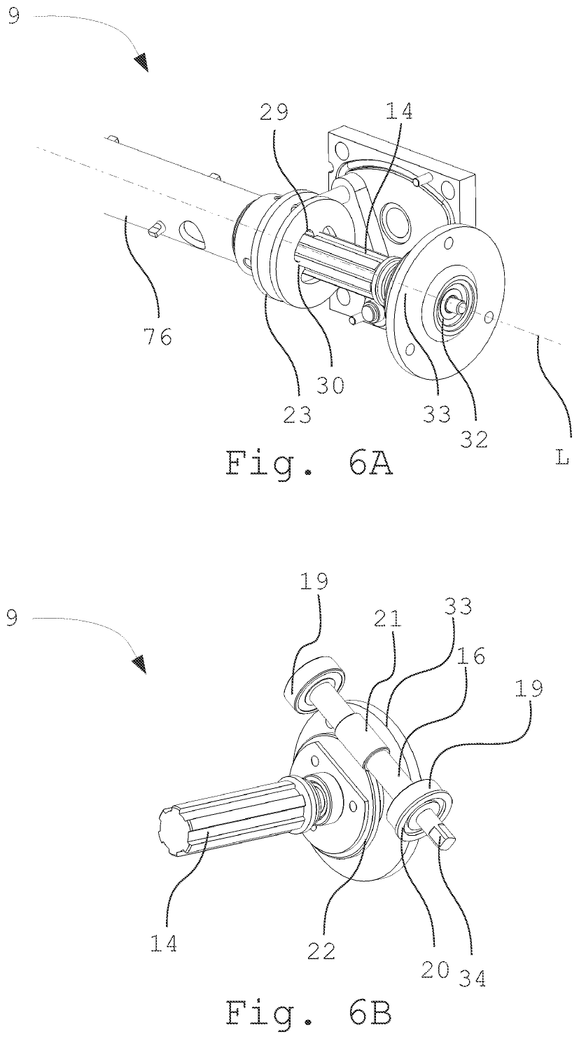

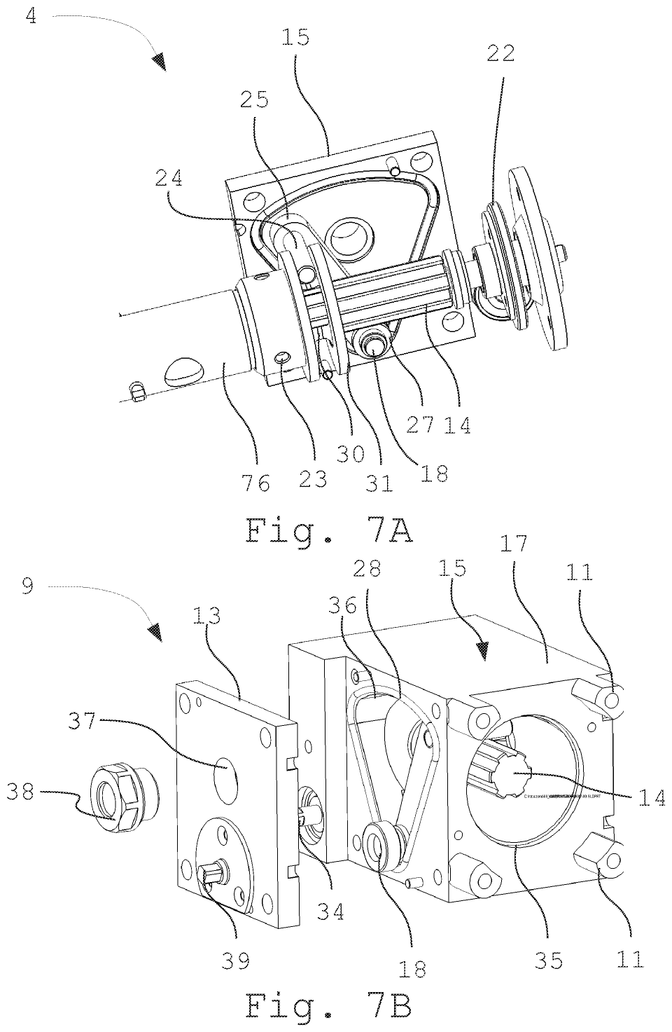

FIGS. 6A to 7B show different views of the drive unit 9.

FIG. 6A shows the shaft 76 with the switching element 23. The switching element 23 is mounted at one end of the shaft and has at its end a cam receiver 29. The cam receiver 29 engages by means of cams 30 with a splined shaft 14. The actuating means (shaft 76 and switching element 23) are displaceable in their longitudinal direction L and may be pushed onto the splined shaft 76 and receive the splined shaft 14 in the interior 73 thereof. As a result, a rotation may be transmitted to the switching element 23 and thus to the shaft 76 via the splined shaft 14. Since the splined shaft 14 is axially displaceable relative to the switching element 23, no axial forces are transmitted to the splined shaft 14. The splined shaft 14 is axially immovable.

FIG. 6B shows how a rotation is transmitted to the splined shaft 14. The splined shaft is held by a rotary bearing (ball bearing 32, FIG. 6A) and sealed outwardly via a seal. A seal which outwardly seals the splined shaft 14 is arranged between a ball bearing support 33 and a housing 15 (see FIG. 7B). The rotation is transmitted via a worm gear to the splined shaft 14. A worm shaft is held by two rotary bearings which in each case are sealed by a V-ring seal. The worm shaft 16 has at one end a square head 34 to which a motor may be attached. The rotation of the worm shaft 16 is transmitted via a shaft thread 21 to a worm wheel 22. The worm wheel 22 is connected fixedly to the axis of the splined shaft 14, so that a rotation of the worm shaft 16 is transmitted via the worm wheel 22 to the splined shaft 14.

FIG. 7A shows a further view of the drive unit 9 in combination with the actuating means 70 (shaft 76, switching element 23). FIG. 7A shows how the actuating means 70 are axially moved. An axial movement is transmitted to the shaft 76 by means of a rotary arm 25. The rotary arm 25 is rotated at a first end about a rotary bearing 27 and at a second end has a pin 24 which extends at right angles to the rotary arm 25. A drive shaft 18 which extends through a housing 15 is fixed to the first end of the rotary arm 25.

The switching element 23 contains at its end in the direction of the drive unit 9 a disk 31 which is connected via the cams 30 to the remaining switching element 23. The pin 24 is guided between the disk 31 and the remaining switching element 23. It should be mentioned that any radial recess which may also extend in the circumferential direction might also be suitable.

By means of the guidance, the pin 24 is able to transmit forces in the axial direction whilst the pin 24 is free in the radial direction of the shaft. If the pin 24 is moved via the rotary arm 25 about the rotary bearing 27, the shaft 76 is displaced in its axial direction to and fro without radial forces acting thereon. At the same time, in the proposed device the drive in the radial direction and the drive in the axial direction are decoupled from one another and may be actuated independently of one another.

FIG. 7B shows a complete housing 15 for the drive unit 9. The housing 15 comprises a first housing part 17, the four connectors 11 for the threaded rods 6 being provided thereon. The housing 15 has a first opening 35 to which the valve element 12h is attached. A cover 13 closes a second opening 36, wherein the drive shaft 18 extends through the cover 13 with a square head 39 for driving the arm 25. Moreover, the cover 13 has a hole 37 for ventilation or emptying. Since when used as intended the hole is oriented downwardly (in particular in the direction of the valve lines 2), a residual fluid in the main line may be optionally discharged through the hole 37 in the case of maintenance. The hole 37 may be closed by a closure 38.

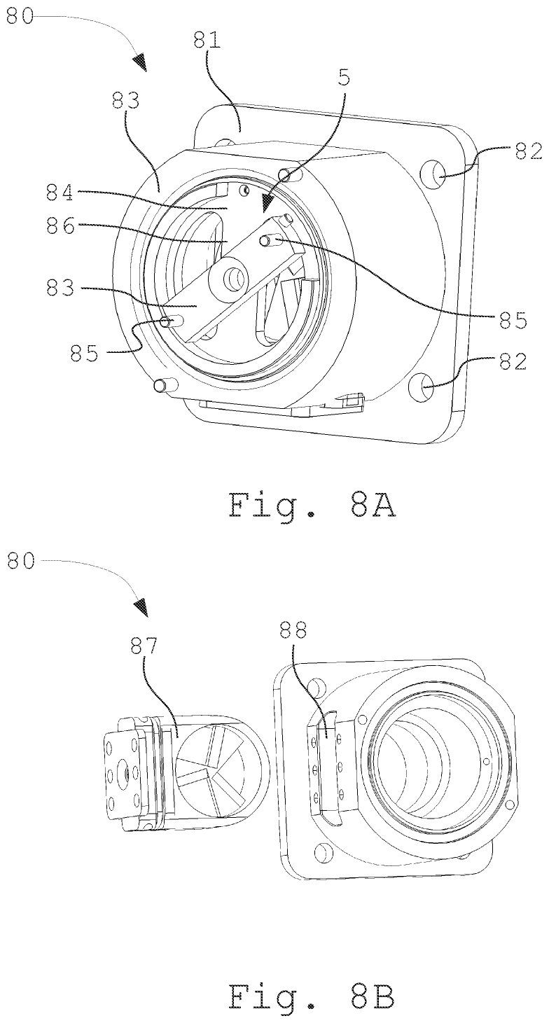

FIG. 8A shows a perspective view of the component 80. The component 80 has a flange 81 with through-holes 82. The through-holes 82 receive the threaded rods 6. By means of a nut the flange 81 may be pushed in the direction of the drive unit 9 and thus fix the valve elements 12. The component 80 has a component body 83. The body 83 is tubular and adjoins the valve elements 12 as shown in FIG. 1. In this case the component 80 forms a part of the main line 1. A pressure equalization device 5 is arranged in the component 1 in the main line 1. The pressure equalization device 5 comprises a hydraulic stator 84 and a slide which is configured as a hydraulic rotor 83.

The hydraulic stator 84 is fixed transversely to the main line 1. The hydraulic rotor 83 is fixed to the hydraulic stator 84. The hydraulic rotor has two pins 85 which may be activated by the actuating means 70. If the hydraulic rotor 83 is actuated, it is rotated about the longitudinal axis of the main line 1. In this case, the hydraulic rotor 83 is at least partially fixed to a web 86 which extends through the main line 1.

If a volumetric flow through the component 80 is too great the hydraulic rotor 83 may be rotated so that a greater cross section of the main line 1 is covered. As a result, a volumetric flow is reduced in a return line. Moreover, a pressure on the inflow side may be increased thereby so that a flow is reduced.

FIG. 8B also shows the component 80 but rotated by 90° relative to FIG. 8A. In contrast to FIG. 8A, the hydraulic rotor 83 and hydraulic stator 84 are not visible. The component 80 additionally comprises a flow sensor 87 which may be configured as an impeller, as shown. The impeller measures a flow through the closing-off part 80. The sensor 87 may be inserted into the main line 1 through a lateral opening 88. As a result, the sensor 87 may also be easily removed again or replaced.

Since the sensor is arranged at the outflow 8 of the assembly M, the entire flow through the assembly may be measured.

1-34. (canceled)

35. A multi-way valve assembly for flow control of a fluid, said valve assembly comprising:
at least first and second valve elements and actuating means for actuating the valve elements,
wherein the valve elements are arranged in such a way that, depending on a position of the actuating means, at least one predetermined valve element can be selected and actuated,
the actuating means are arranged to be translationally displaceable, and
in a first translational position of the actuating means, the first valve element can be actuated, and, in a second translational position different from the first translational position, the second valve element can be actuated.

36. The multi-way valve assembly as claimed in claim 35, wherein the actuating means comprise a shaft and the shaft is arranged to be axially displaceable along its axis so that, in a first axial position of the shaft, the first valve element is actuatable and, in a second axial position which is different from the first translational position, the second valve element is actuatable.

37. The multi-way valve assembly as claimed in claim 35, further comprising a pressure equalization device, which is actuatable in a third axial position.

38. The multi-way valve assembly as claimed in claim 35, wherein the valve assembly has a third valve element and, in the first translational position of the actuating means, the first valve element and the third valve element are actuatable.

39. The multi-way valve assembly as claimed in claim 38, wherein the first valve element is selectable by a first rotational position of the actuating means, and the third valve element is selectable by a second rotational position which is different from the first translational position.

40. The multi-way valve assembly as claimed in claim 38, wherein the first valve element is actuatable by a rotation of the actuating means in a first direction and the third valve element is actuatable by a rotation in a second direction, which is different from the first direction.

41. The multi-way valve assembly as claimed in claim 36.

42. The multi-way valve assembly as claimed in claim 35, wherein the valve elements have a valve body and a diaphragm, and
the diaphragm is movable relative to the valve body and is movable by the actuating means.

43. The multi-way valve assembly as claimed in claim 42, wherein at least one of the diaphragms has a driver for the actuating means, and the diaphragm has at least a first and a second offset receiver for the driver.

44. A multi-way valve assembly for flow control and distribution of a fluid, comprising:
at least first and second valve lines and a common main line,
at least first and second valve elements for closing and opening the first, and respectively the second, valve lines,
wherein the valve elements are arranged between the valve line and the main line, and
actuating means for actuating the valve elements, and
an actuatable pressure equalization device is provided for pressure equalization in the main line.

45. The multi-way valve assembly as claimed in claim 44, wherein the pressure equalization device is arranged such that a fluid flow through the assembly passes substantially entirely through the pressure equalization device.

46. The multi-way valve assembly as claimed in claim 44, wherein the pressure equalization device comprises a slide, and the slide is slidable in an outlet cross section.

47. The multi-way valve assembly as claimed in claim 46, wherein the pressure equalization device is designed to close the outlet cross section partially.

48. The multi-way valve assembly as claimed in claim 44, wherein the pressure equalization device is actuatable by a drive.

49. The multi-way valve assembly as claimed in claim 48, wherein the pressure equalization device is actuatable by the same actuating means as the valve elements.

50. A multi-way valve assembly, for flow control and distribution of a fluid, comprising:
at least first and second valve lines and a common main line,
at least first and second valve elements for closing and opening the first and second valve lines, respectively,
wherein the valve elements are arranged between the first and second valve lines and the main line, and
actuating means for actuating the first and second elements,
wherein the actuating means has a shaft which is arranged in the main line, and the shaft is of hollow configuration so that the fluid may flow through the shaft.

51. The multi-way valve assembly as claimed in claim 50, wherein the shaft has holes so that a fluid may flow from outside to inside and may flow out of the shaft at one end of the shaft.

52. The multi-way valve assembly as claimed in claim 50, wherein the shaft is open at least at one end

53. The multi-way valve assembly as claimed in claim 37,
wherein the pressure equalization device has a component which has a measuring cell.

54. The multi-way valve assembly as claimed in claim 53, wherein the measuring cell is replaceable.

55. A multi-way valve assembly for flow control and distribution of a fluid comprising:
at least first and second valve lines and a common main line,
at least first and second valve elements for closing and opening the first and second valve lines, respectively,
wherein the valve elements are arranged between the valve line and the main line, and
actuating means for actuating the valve elements,
the valve assembly has a drive unit for the actuating means, and
the drive unit has a drive shaft for a motor having a rotational direction perpendicular to a longitudinal direction of the main line.

56. The multi-way valve assembly as claimed in claim 55, wherein a motor for the drive unit is arranged laterally offset to a longitudinal axis of the main line.

57. The multi-way valve assembly as claimed in claim 55, wherein the drive unit is designed to displace and to rotate the actuating means axially with respect to the main line.

58. The multi-way valve assembly as claimed in claim 50, wherein the valve elements have, in each case, a valve body with an opening for the valve line which is closable by a diaphragm,
a seal is attached between the opening and the diaphragm, and
the seal is pressed against the diaphragm

59. The multi-way valve assembly as claimed in claim 34, wherein the device has a drive unit, the drive unit has a pivoting arm, the pivoting arm is coupled, at one end, to the actuating means, and the pivoting arm is arranged such that the actuating means is axially displaceable by a rotation of the pivoting arm.

60. The multi-way valve assembly as claimed in claim 59, wherein the pivoting arm and the actuating means are coupled such that only forces axially to the main line are able to be transmitted from the pivoting arm to the actuating means.

61. The multi-way valve assembly as claimed in claim 55, wherein the actuating means has a shaft and the drive unit has a worm gear in order to rotate the shaft about its own axis.

62. The multi-way valve assembly as claimed in claim 58, wherein all of the seals are annular around movable parts.

63. The multi-way valve assembly as claimed in claim 35, wherein the first and the second valve element have, in each case, a valve body and the valve bodies are arranged adjacent to one another in a longitudinal direction relative to the main line.

64. The multi-way valve assembly as claimed in claim 35, wherein at least one sliding element is arranged between a valve body of the valve element and a diaphragm of the valve element.

65. The multi-way valve assembly as claimed in claim 35, wherein at least one valve element has a movable diaphragm, and the valve assembly further comprises a stop device limiting movement of the diaphragm.

66. The multi-way valve assembly as claimed in claim 65, wherein the diaphragm is of a hollow-cylindrical configuration and is arranged to be rotatable about its axis, and the stop device is configured by a pin which is guided in a slot.

67. The multi-way valve assembly as claimed in claim 38, wherein the first or the third valve element is selectable and actuatable as a function of an amount of angular rotation of the actuating means.

68. The multi-way valve assembly as claimed in claim 39, wherein the rotational position is selectable in a third translational position.
